(19) United States
(12) Patent Application Publication
(10) Pub. No.: US 2025/0325956 A1
(43) Pub. Date: Oct. 23, 2025

(54) ALGAE-BASED BIOMASS MATERIAL FOR EFFLUENT GAS STREAM AND ASSOCIATED METHOD AND APPARATUS

(71) Applicant: ECO RESEARCH SDN. BHD., Pulau Pinang (MY)

(72) Inventors: Chee Wei CHAN, Pulau Pinang (MY); Kah Aik TAN, Pulau Pinang (MY); Nur Syazwani Abd Rahman, Pulau Pinang (MY); Jia Ee Chirstel CHONG, Pulau Pinang (MY)

(21) Appl. No.: 19/183,040

(22) Filed: Apr. 18, 2025

Related U.S. Application Data
(60) Provisional application No. 63/636,229, filed on Apr. 19, 2024.

(51) Int. Cl. B01J 20/20; B01D 53/02; B01J 20/18; B01J 20/24; B01J 20/28

(52) U.S. Cl. CPC B01J 20/20; B01D 53/02; B01J 20/18; B01J 20/24; B01D 2257/206; B01D 2258/0216; B01J 20/28011; B01J 2220/42; B01J 2220/44; B01J 2220/4843

(57) ABSTRACT

A biomass material for treating an effluent gas stream includes an algae biomass in an amount of from 40 weight % to 90 weight % based on a total weight of the biomass material and a zeolite in an amount of from 10 weight % to 60 weight % based on a total weight of the biomass material.

### CROSS REFERENCE TO RELATED APPLICATIONS

This application claims priority of U.S. Provisional Application No. 63/636,229 filed on Apr. 19, 2024 under 35 U.S.C. § 119 (e), the entire contents of all of which are hereby incorporated by reference.

### FIELD OF THE INVENTION

The present invention relates generally to gas treatment technologies, and more particularly to an algae-based biomass material comprising algae biomass and zeolite for adsorption of gaseous pollutants in effluent gas streams.

### BACKGROUND OF THE INVENTION

In industries such as manufacturing, electronics, and chemical engineering-including semiconductor, display, solar panel, and thin-film processes various gaseous pollutants containing harmful chemical substances are produced.

Common treatment methods include combustion, plasma, water scrubbing, and catalytic processing. Among them, combustion and plasma methods have higher decomposition efficiency. Conventional exhaust gas treatment apparatus, such as those disclosed in U.S. Pat. Nos. 12,161,964B2, 12,158,266B2, 11,985,754B2, and publications US 2024/0375158A1, US 2024/0381519A1, and US 2024/0082782A1, present limitations.

For example, in a semiconductor production process, various kinds of gases are used, such as monosilane (SiH₄), chloride gas, PFC (perfluorinated compounds) and etc., those compounds have a great impact on the global environment. In the case where monosilane is included in the processing target exhaust gas, a processing device such as a pyrolysis type, a combustion type, or a chemical reaction type is used. In the case where chloride gas is included in the processing target exhaust gas, a processing device such as a wet type using a chemical solution is used. In addition, in the case where PFC is included in the processing target exhaust gas, an exhaust gas processing device such as a catalyst type, a thermal reaction type, a pyrolysis type, a combustion type, or a plasma type is used.

Whatever which type of method is used, the treated gas processed by the exhaust gas treatment apparatus still contains residually harmful substances.

### SUMMARY OF THE INVENTION

One aspect of the present disclosure provides a biomass material for treating an effluent gas stream. The biomass material comprises an algae biomass in an amount of from 40 weight % to 90 weight % based on a total weight of the biomass material; and a zeolite in an amount of from 10 weight % to 60 weight % based on a total weight of the biomass material.

One aspect of the present disclosure provides a method of treating an effluent gas stream, comprising the step of: providing a biomass adsorbent at a downstream of the effluent gas stream from one or more processes, wherein the biomass adsorbent comprises an algae biomass in an amount of from 40 weight % to 90 weight % based on a total weight of the biomass material and a zeolite in an amount of from 10 weight % to 60 weight % based on a total weight of the biomass material; and contact the effluent gas stream with the biomass adsorbent, wherein the biomass adsorbent absorbs at least one of target components in the effluent gas stream, wherein the target components comprise tetrafluoromethane, carbon dioxide, methane, sulfur dioxide, nitrogen oxides, volatile organic compounds, and/or hydrogen sulfide.

One aspect of the present disclosure provides an apparatus for treating an effluent gas stream. The apparatus comprises a reactor and a biomass adsorbent. The reactor is coupled to process chambers through one or more gas introduction lines, wherein the reactor is configured to abate exhaust gases from one or more processes. The biomass adsorbent is provided downstream of the reactor, wherein the biomass adsorbent comprises an algae biomass in an amount of from 40 weight % to 90 weight % based on a total weight of the biomass material and a zeolite in an amount of from 10 weight % to 60 weight % based on a total weight of the biomass material.

### BRIEF DESCRIPTION OF DRAWINGS

FIG. 1 is a block diagram showing a configuration of a semiconductor processing system according to an example in the present disclosure;

FIG. 2 is a block diagram showing a configuration of a semiconductor processing system according to another example in the present disclosure.

FIG. 3 is a flowchart illustrating a method of making the biomass material according to an example in the present disclosure;

FIG. 4 illustrates an example of an exhaust gas abatement apparatus in the present disclosure;

FIG. 5 illustrates another example of an exhaust gas abatement apparatus in the present disclosure; and

FIG. 6 illustrates a method of treating an effluent gas stream according to an example in the present disclosure.

### DETAILED DESCRIPTION

The present disclosure is generally directed to a biomass material used as bio-based adsorbents for treating an effluent gas stream containing gaseous pollutants, which can treat effluent streams from semiconductor, display panel, solar panel, and other manufacturing processes. Examples of pollutants treated include waste gas contaminants such as perfluorinated compounds (PFCs), silane and its derivatives, chlorinated compounds, nitrogen-containing compounds, volatile organic compounds (VOCs), and metal-organic compounds, which are harmful to the environment and human health.

The present disclosure introduces a novel approach by incorporating algae and zeolite as the bio-based adsorbents, offering a sustainable and cost-effective solution to incomplete gas removal occurred in conventional scrubbers. The bio-based adsorbents provided by the present disclosure have advantages of excellent adsorption capacity, low operational costs, and no potential secondary pollution. By utilizing natural and renewable materials, the bio-based adsorbent improve adsorption efficiency while reducing environmental footprint, making it a more sustainable solution for gas treatment applications.

The bio-based adsorbents may be fabricated into an adsorption unit as a standalone exhaust gas treatment device. Alternatively, the adsorption unit may be integrated into an exhaust gas treatment apparatus as one of its components. For instance, the adsorption unit may be a part of a combustion and-scrubbing type exhaust treatment system or a combustion-based exhaust treatment system.

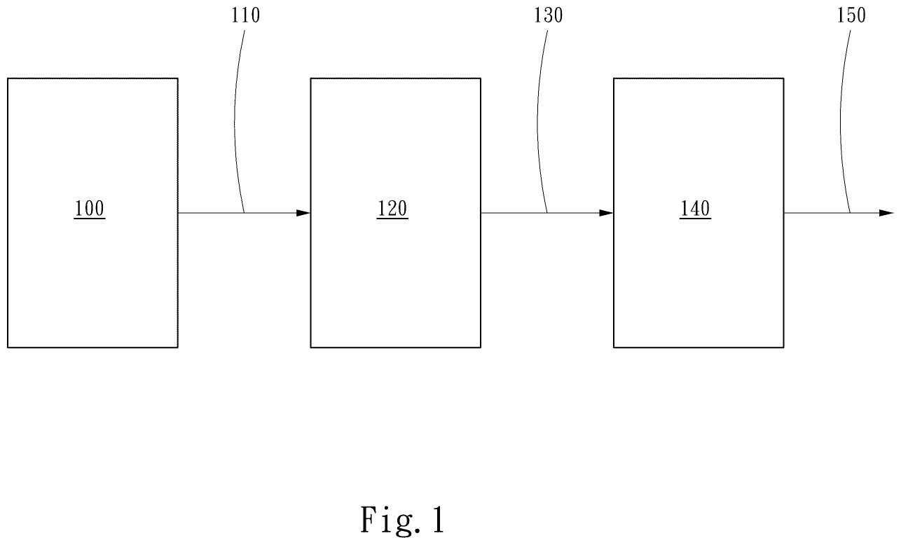

FIG. 1 is a block diagram showing a configuration of a semiconductor processing system according to the present disclosure. The system comprises a semiconductor processing apparatus 100, for example, a semiconductor processing chamber that is capable of executing one or more lithography, deposition, and/or etch steps using various precursor chemical vapors. The semiconductor processing apparatus 100 may be connected via a fore line 110 to a vacuum pump 120. The exhaust gas from the processes in the semiconductor processing apparatus 100 is discharged from vacuum pump 120 through an exhaust line 130.

The exhaust gas may be conveyed through the exhaust line 130 to an exhaust gas abatement apparatus 140, where the exhaust gas is processed. The processing comprises exposing the exhaust gas to the bio-based adsorbents of the exhaust gas abatement apparatus 140. The processed exhaust gases are then allowed to exit the exhaust gas abatement apparatus 140 through a gas outlet 150.

In one example, the exhaust gas is processed only by the bio-based adsorbents of the exhaust gas abatement apparatus 140, without processed by a method other than the adsorption type. For example, the exhaust gas is not processed by a method that is of a combustion type, a thermal decomposition type, a wet type, a catalytic type, a plasma decomposition type, or the like.

In another example, the bio-based adsorbents may combine with a combustion type, a thermal decomposition type, a wet type, a catalytic type and/or a plasma decomposition type scrubber to form the exhaust gas abatement apparatus 140.

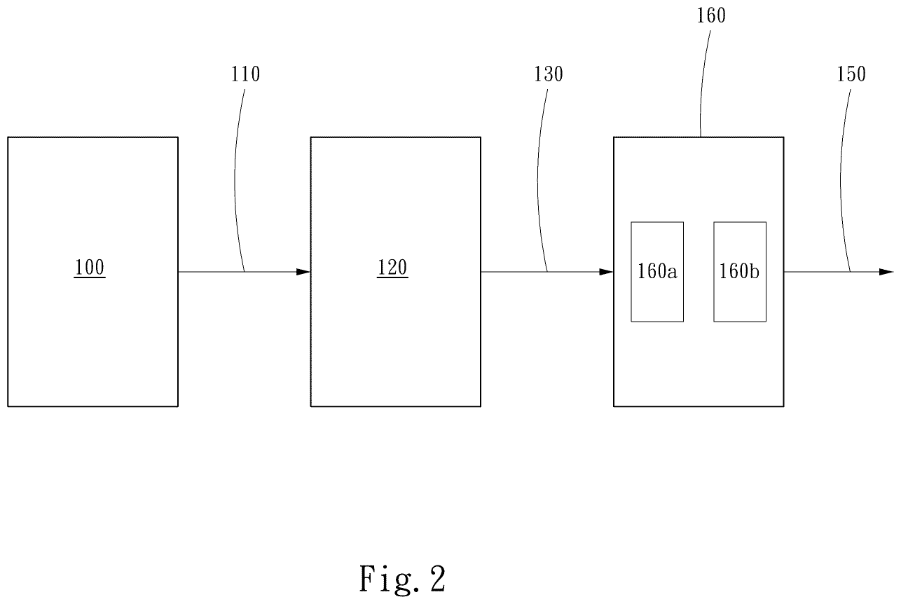

FIG. 2 is a block diagram showing a configuration of a semiconductor processing system according to the present disclosure. Compared to the configuration in FIG. 1, the exhaust gas abatement apparatus 160 includes a reactor 16a and a biomass adsorbent 160b. The reactor 160a is coupled to the semiconductor processing apparatus 100 through one or more gas introduction lines. The reactor 160a is configured to abate exhaust gases from one or more processes. The reactor 160a may be a combustion type, a thermal decomposition type, a wet type, a catalytic type and/or a plasma decomposition type scrubber.

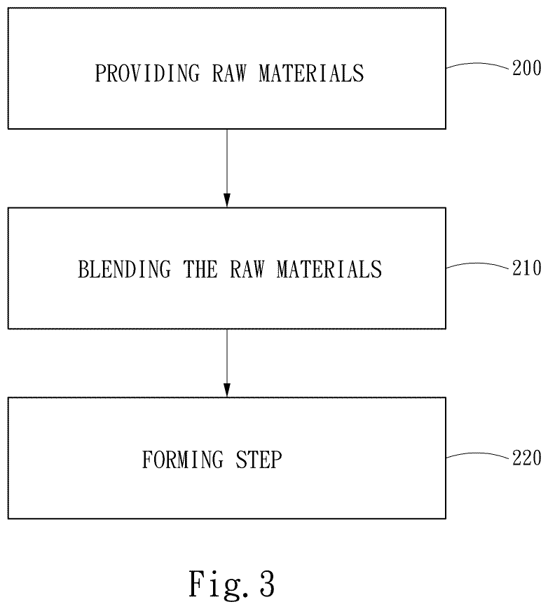

With reference to FIG. 3, a method of making the biomass material according to an example embodiment is illustrated. At 200, an algae biomass and a zeolite are provided. At 210, the algae biomass and the zeolite are mixed in a specific proportion. The mixing may be achieved by mechanical stirring, palletization, or other suitable methods to ensure uniform distribution. Then, at 220, the mixture is subjected to drying so as to remove moisture and activate the adsorption sites. Drying may be performed using various methods such as air drying, vacuum drying, or oven drying at a suitable.

In one example, the algae biomass is carbonized algae. The harvested algae from natural sources or artificially cultivated are dried prior to carbonization. The algae are heated to an elevated temperature under a protective atmosphere and maintained to ensure carbonization. After cooling, the carbonized algae were collected and mixed with the zeolite to obtain a mixture. The mixture was homogenized through blending to ensure uniform distribution. Following blending, the mixture was pelletized by adding solvent to form pellets. The pellets were then dried to remove moisture and improve structural stability before further forming. The pellets can be directly applied by packing them into a column for testing purposes. This form is suitable for fixed-bed setups, allowing for uniform gas flow, reliable contact with the adsorbent surface, and consistent performance evaluation under controlled conditions.

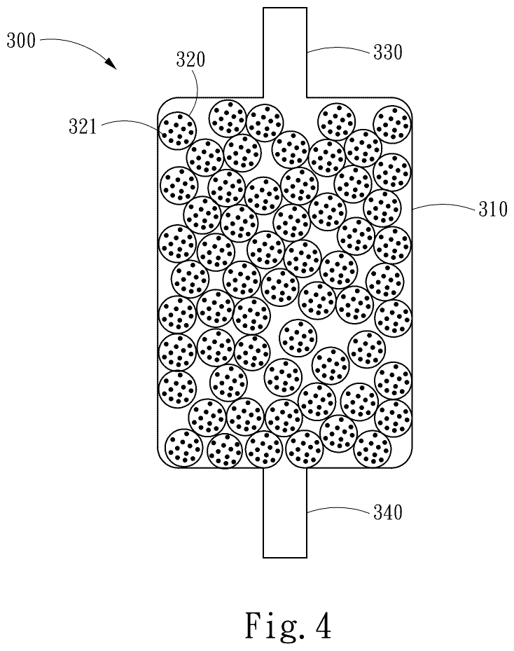

FIG. 4 illustrates an example of an exhaust gas abatement apparatus 300. The exhaust gas abatement apparatus 300 includes a housing 310 and a plurality of pellets 320 packed inside the housing 310. The housing 310 is connected to an upstream exhaust line 330 for guiding the exhaust gas to the packed pellets 320 and a downstream exhaust line 340 for discharging the processed exhaust gas.

In this example, each of the pellets 320 consists of the biomass material without any other additives or additional components. The pellet 320 has a porous structure 321. In the example, the pore size is in a range sufficient for capturing of gas molecules in the exhaust gas. While in other examples, the pellets 320 may be a combination or a composite material of the biomass material and other materials.

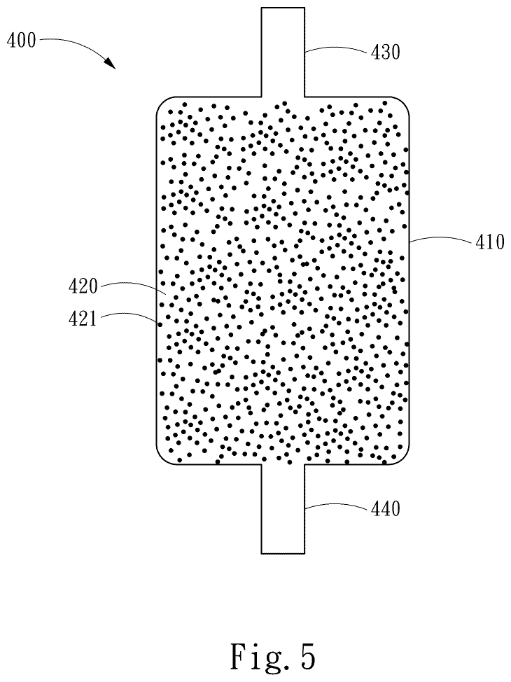

FIG. 5 illustrates an example of an exhaust gas abatement apparatus 400. The exhaust gas abatement apparatus 400 includes a housing 410 and a bio-based adsorbent 420 disposed inside the housing 410. The housing 410 is connected to an upstream exhaust line 430 for guiding the exhaust gas to the bio-based adsorbent 420 and a downstream exhaust line 440 for discharging the processed exhaust gas.

In this example, the bio-based adsorbent 420 consists of the biomass material without any other additives or additional materials. The bio-based adsorbent 420 has a porous structure 421. In the example, the pore size is in a range sufficient for capturing of gas molecules in the exhaust gas. While in other examples, the bio-based adsorbent 420 may be a combination or a composite material of the biomass material and other materials.

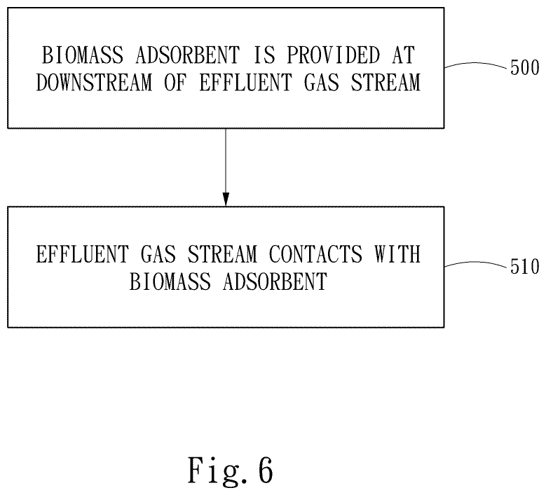

With reference to FIG. 6, a method of treating an effluent gas stream is illustrated. At 500, a biomass adsorbent is provided at a downstream of the effluent gas stream from one or more processes. The biomass adsorbent comprises an algae biomass in an amount of from 40 weight % to 90 weight % based on a total weight of the biomass material and a zeolite in an amount of from 10 weight % to 60 weight % based on a total weight of the biomass material. At 510, the effluent gas stream contacts with the biomass adsorbent. The biomass adsorbent absorbs at least one of target components in the effluent gas stream, the target components comprise tetrafluoromethane, carbon dioxide, methane, sulfur dioxide, nitrogen oxides, volatile organic compounds, and/or hydrogen sulfide. In one example, the target components are selected from a group consisted of tetrafluoromethane, carbon dioxide, methane, sulfur dioxide, nitrogen oxides, volatile organic compounds, and hydrogen sulfide.

The biomass material for treating the effluent gas stream comprises an algae biomass in an amount of from 40 weight % to 90 weight % based on a total weight of the biomass material and a zeolite in an amount of from 10 weight % to 60 weight % based on a total weight of the biomass material. In an example, the biomass material consists of the algae biomass and the zeolite without any other additional compositions. While in some example, the biomass material may further include other additional compositions.

In certain examples, the algae biomass may be presented in an amount of 40, 45, 50, 55, 60, 65, 70, 75, 80, 85, 90 weight % based on the total weight of the biomass material. In certain examples, the zeolite may be presented in an amount of 10, 15, 20, 25, 30, 35, 40, 45, 50, 55, 60 weight % based on the total weight of the biomass material.

In an example, the biomass material has a gas adsorption capacity more than 0.029 mol/g. For example, the gas adsorption capacity may be in a range between 0.029 mol/g and 5 mol/g.

The algae biomass may be a single species or a mix of two or more species, preferably protein-rich algae, with a protein content of at least 30 weight %, such as Spirulina sp., Chlorella sp., and Nannochloropsis sp. These species are selected due to their exceptional high surface area, abundant functional groups (e.g., hydroxyl, carboxyl, and amine), and rich carbon content, which enhance pollutant binding. The algae exhibit porous cell walls structure, which may be further modified through carbonization for improved adsorption efficiency. These algae are fast-growing, sustainable, and cost-effective, making them eco-friendly alternatives to synthetic adsorbents. In an example, the algae biomass used in the present disclosure is cultivated under controlled conditions, as opposed to wild-type algae collected from natural environments. Namely, the algae biomass is artificially cultivated and harvested. In another example, however, the algae biomass may be naturally sourced algae.

The algae biomass in the material possesses a high surface area, intricate cellular morphology, and a diverse composition rich in biopolymers such as proteins, lipids, and polysaccharides with large polymeric structures. These characteristics provide numerous functional groups—such as hydroxyl, carbonyl, and amino groups—that serve as active sites for gas molecule adsorption through both physical and chemical interactions. The biological nature of algae further enables dynamic interactions with gas atoms, including dipole-dipole forces, electrostatic interactions, and π-π electron donor acceptor mechanisms, thereby enhancing overall adsorption performance. In addition to its adsorption capacity, algae biomass is renewable, abundant, and environmentally friendly, making it an attractive material for applications such as carbon capture and biogas purification, where it can effectively remove pollutants like carbon dioxide, methane, and hydrogen sulfide from gas streams.

Zeolites are microporous crystalline solids with well-defined structures. The zeolites generally comprise silicon, aluminium and oxygen with the aluminum and silicon atoms at the centre of oxygen atom tetrahedra. The pores of the zeolite structure can contain cations, water and other molecules. The cations may be metal ions and these are generally loosely bound to the zeolite.

Zeolites possess a highly porous structure and a well-defined crystalline structure, which collectively provide a large surface area suitable for adsorption. These structural characteristics allow for the selective capture of gas molecules and ions based on parameters such as molecular size, shape, and charge. In certain embodiments, zeolites exhibit ion-exchange capabilities, wherein cations within the framework may be displaced to facilitate or enhance adsorption of target species.

Additionally, some gas molecules may undergo chemical interactions with the zeolite surface, further contributing to adsorption efficiency. Due to their uniform pore distribution, molecular sieving properties, and tunable chemical characteristics, zeolites are particularly suitable for applications involving gas storage, separation, and purification. Furthermore, zeolites are capable of being regenerated and reused, thereby offering advantages in terms of cost-effectiveness and long-term applicability in industrial and environmental systems. Zeolite options suitable for use according to the present disclosure include but not limiting to Zeolite 13X, Type A Zeolite, Zeolite Beta, and H-ZSM-5, due to their high surface area, well-defined pore structures, and strong affinity for gas molecules. These properties make them effective candidates for adsorbing small gas molecules through physisorption and selective pore-channel interactions.

In an example, H-ZSM-5 may be chosen for CF₄ adsorption due to its optimized pore size, which allows efficient trapping of CF₄ molecules while preventing interference from larger species. Its hydrophobic nature enhances adsorption performance in real-world conditions, reducing the impact of moisture that can degrade other zeolites. Additionally, H-ZSM-5 exhibits excellent thermal stability, making it suitable for long-term use and repeated adsorption-desorption cycles without significant structural degradation. Furthermore, its potential for modification, such as metal doping or integration with carbonized algae, enhances its adsorption capacity and selectivity, making it a versatile and effective adsorbent for CF₄ removal.

When the algae biomass combined with the zeolite, the algae biomass acts synergistically to improve gas adsorption efficiency. The zeolite provides a well-defined crystalline framework and uniform pore structure that contributes to structural stability and molecular sieving capabilities, while the algae biomass introduces additional surface area and biologically active adsorption sites. This combination leverages the strengths of both materials, resulting in a composite with enhanced gas adsorption performance compared to either component used alone.

The biomass adsorbent exhibits superior adsorption capacity and selectivity for a wide range of gases, including but not limited to carbon dioxide (CO₂), methane (CH₄), sulfur dioxide (SO₂), nitrogen oxides (NOX), tetrafluoromethane (CF₄), volatile organic compounds (VOCs), and hydrogen sulfide (H₂S). The synergistic combination of zeolite and algae biomass results in enhanced adsorption performance due to the unique properties of each component.

Hereinafter, the present disclosure will be described in more detail through specific examples. The following examples are only examples to help the understanding of the present disclosure, and the scope of the present disclosure is not limited thereto.

### Examples

Various examples of the present invention as well as comparative examples have been prepared and evaluated.

Table I summarizes the composition of the adsorbents in Inventive Examples (Ex. A1-A5 and Ex. B1-B5) and Comparative Example (EX. C-1). Non-carbonized algae are used in Inventive Examples Ex. A1-A5 and carbonized algae are used in Inventive Examples Ex. B1-B5. The Inventive Examples and Comparative Example differ in the amount of the algae and the zeolite. CF₄ containing gas is used to assess the adsorption capacity for each sample. The results of adsorption capacity and structure stability are shown in Table II.

### Inventive Examples Ex. A1-A5 and Comparative Examples EX. C-1-C2

The non-carbonized Spirulina sp. is selected as algae, which are dried after harvested. Then the algae are blended with H-ZSM-5 at varying ratios as listed in Table I. Following blending, the mixture was pelletized by adding a small amount of water to form pellets. The pellets were then dried at 110° C. for 12 hours.

### Inventive Examples Ex. B1-B5

The harvested algae are carbonized in a reactor at 500° C. under a nitrogen (N₂) gas atmosphere. The heating process was maintained for 2 hours to ensure sufficient carbonization. After cooling, the algae are blended with H-ZSM-5 at varying ratios as listed in Table I. Following blending, the mixture was pelletized by adding a small amount of water to form pellets. The pellets were then dried at 110° C. for 12 hours.

TABLE I

| | Non-Carbonized | Carbonized Algae | Zeolite |
|---|---|---|---|
| Sample | Algae (wt. %) | (wt. %) | (wt. %) |
| Ex. A-1 | 40% | 0 | 60% |
| Ex. A-2 | 50% | 0 | 50% |
| Ex. A-3 | 60% | 0 | 40% |
| Ex. A-4 | 70% | 0 | 30% |
| Ex. A-5 | 90% | 0 | 10% |
| Ex. B-1 | 0 | 40% | 60% |
| Ex. B-2 | 0 | 50% | 50% |
| Ex. B-3 | 0 | 60% | 40% |
| Ex. B-4 | 0 | 70% | 30% |
| Ex. B-5 | 0 | 90% | 10% |
| Ex. C-1 | 100% | 0 | 0 |
| Ex. C-2 | 0 | 100% | 0 |

TABLE II

| Sample | Structure stability | Adsorption capacity (mol/g) |
|---|---|---|
| Ex. A-1 | ◯ | 0.0467 |
| Ex. A-2 | ◯ | 0.0522 |
| Ex. A-3 | ◯ | 0.0676 |
| Ex. A-4 | ◯ | 0.0392 |
| Ex. A-5 | ◯ | 0.0291 |
| Ex. B-1 | ◯ | 1.6806 |
| Ex. B-2 | ◯ | 1.4511 |
| Ex. B-3 | ◯ | 2.0627 |
| Ex. B-4 | ◯ | 0.4270 |
| Ex. B-5 | ◯ | 0.3700 |
| Ex. C-1 | ◯ | 0.0013 |
| Ex. C-2 | X | 1.0226 |

The results show that the Inventive Examples with carbonized algae have better adsorption capacity than those without carbonization. It is found that carbonization may change the natural structure of the algae, i.e. expanding the pore size and the porosity, so as to facilitate the adsorption of CF₄ molecules in the gas stream. Carbonized algae outperforms pure algae due to its significantly higher surface area and porosity, providing more active sites for gas adsorption. Additionally, the carbonization process improves thermal stability and mechanical strength of the algae, ensuring better long-term performance. Furthermore, carbonized algae may be tailored with specific pore sizes and surface characteristics, making it a more efficient and effective adsorbent than pure algae.

The adsorption capacity of an adsorbent measures how much gas, such as CF₄, it can hold per unit mass. This value helps confirm that the gas is being adsorbed by the material. When gas molecules are introduced to the adsorbent, they interact with the pore surface and get trapped, either through weak physical forces or stronger chemical bonds. A higher adsorption capacity indicates that the adsorbent is effectively capturing and holding more gas molecules. This capacity is influenced by factors like the surface area and pore structure of the adsorbent, as more surface area means more room for gas molecules to stick. Essentially, a high adsorption capacity shows that the adsorbent has a greater ability to remove gas from the surrounding environment, proving that the adsorption process is happening.

Inventive Examples Ex. B1-B5 demonstrated high CF₄ gas adsorption capacity, suggesting that adsorption was not driven only by microporosity or surface area. Instead, the performance is likely attributed to the presence of hetero atom-containing functional groups (e.g., N, O) and surface defects formed during carbonization, which promote specific interactions with CF₄ molecules. Additionally, macropores and external surfaces may offer accessible pathways for gas adsorption. This highlights that in certain carbonized algae, surface chemistry and morphology play a more critical role than surface area alone in determining gas adsorption efficiency, particularly for weakly interacting gases like CF₄.

Compared to values reported in the literature, the carbonized algae with zeolite adsorbent (Inventive Examples Ex. B1-B5) demonstrates a significantly higher CF₄ adsorption capacity of 2.0627 mol/g. Several other adsorbents have shown comparatively lower capacities, as outlined in TABLE III below:

TABLE III

| | Adsorption Capacity | |
|---|---|---|
| Adsorbent | (mol/g) | Reference |
| Non-carbonized algae with zeolite (Ex. | 0.0291~0.0676 | — |
| A1-A5) | | |
| Carbonized algae with | 0.3700~2.0627 | — |
| zeolite (Ex. B1-B5) | | |
| Microporous carbon from PVDF | 0.00185 | [1] |
| Microporous carbon | 0.00279 | [2] |
| from petroleum coke | | |
| Porous carbon from silicon carbide | 0.00232 | [3] |

The literature citations in the TABLE I are given in the TABLE IV below:

TABLE IV

| No. | Literature |
|---|---|
| [1] | Choi, S. W., Hong, S. M., Park, J. H., Beum, H. T., Lee, K. B. (2015). CF₄ |
| | adsorption on microporous carbons prepared by carbonization of |
| | poly(vinylidene fluoride). Industrial & Engineering Chemistry |
| | Research, 54(34), 8561-8568. |
| | Yuan, X., Choi, S. W., Jang, E., Lee, K. B. (2018). Chemically activated |
| [2] | microporous carbons derived from petroleum coke: Performance |
| | evaluation for CF₄ adsorption. Chemical Engineering Journal, 336, |
| | 297-305. |
| [3] | Choi, S. W., Yoon, H. J., Lee, H. J., Lee, E. S., Lim, D. S., Lee, K. B. (2020). |
| | CF₄ adsorption on porous carbon derived from silicon carbide. |
| | Microporous and Mesoporous Materials, 306, 110373. |

Additionally, pure non-carbonized algae without zeolite (Ex. C-1) exhibited a very low adsorption capacity of 0.0013 mol/g, while pure carbonized algae without zeolite (Ex. C-2) had an adsorption capacity of 1.0226 mol/g. Although carbonized algae without zeolite demonstrates good CF₄ adsorption, the absence of zeolite results in poor structural stability, rendering it unsuitable for end-use fields. Moreover, its adsorption performance may be less selective in mixed-gas environments. The incorporation of zeolite into carbonized algae enhances structural stability, improves selectivity, and provides additional active sites for adsorption, thereby making the material more viable for long-term applications.

Thus, the synergistic combination of carbonized algae and zeolite provides improved gas adsorption efficiency, utilizing both physical adsorption and chemical interactions to capture and remove pollutants from industrial exhaust streams. The material is designed for integration into existing gas treatment systems, including scrubbing and plasma reactor setups, offering a sustainable and cost-effective alternative to conventional adsorbents. This invention provides an environmentally friendly approach to mitigating industrial emissions while ensuring high adsorption performance and operational feasibility.

Throughout the specification and claims, the use of articles such as “a,” “an,” and “the,” as well as similar referents, shall be interpreted to encompass both the singular and the plural forms, unless the context clearly dictates otherwise. The terms “comprising,” “having,” “including,” and “containing” as used herein are intended to be open-ended terms (i.e., meaning “including, but not limited to”) unless expressly stated otherwise. Although the compositions and methods are generally described using these open-ended terms, alternative embodiments may also be described using the more restrictive terms “consist essentially of” or “consist of,” where appropriate. Additionally, for the purposes of this disclosure, the phrase “X and/or Y” means (X), (Y), or (X and Y), and the phrase “X, Y, and/or Z” means (X), (Y), (Z), (X and Y), (X and Z), (Y and Z), or (X, Y, and Z).

Unless otherwise specified, all numerical values relating to quantities of ingredients, material properties (such as weight or concentration), reaction conditions, and the like, as used in the present disclosure and the appended claims, are to be understood as being modified in all instances by the term “about.” Accordingly, unless expressly indicated otherwise, numerical parameters set forth herein are to be interpreted as approximations that may vary based on the desired functional properties of the embodiments. At a minimum, and without limiting the application of the doctrine of equivalents, each numerical value should be construed in light of the number of significant digits and the use of ordinary rounding techniques.

All methods described herein may be performed in any suitable order unless explicitly stated otherwise or unless the context clearly dictates a specific sequence. The use of examples or exemplary language (e.g., “such as”) is intended to illustrate particular embodiments of the invention and should not be construed as limiting the scope of the invention unless expressly recited in the claims. No language in this specification should be interpreted as designating any non-claimed element as essential to the implementation of the invention.

The foregoing description of various embodiments is provided to enable a person skilled in the art to make and use the present invention. It is understood that modifications and variations to these embodiments will be apparent to those skilled in the art in view of the teachings herein. The general principles and specific examples disclosed may be adapted for use in other embodiments without departing from the scope of the invention. Accordingly, the present invention is not limited to the specific embodiments described, but is intended to be accorded the broadest scope consistent with the claims and applicable legal standards.

What is claimed is:

1. A biomass material for treating an effluent gas stream, comprising:
an algae biomass in an amount of from 40 weight % to 90 weight % based on a total weight of the biomass material; and
a zeolite in an amount of from 10 weight % to 60 weight % based on a total weight of the biomass material.

2. The biomass material of claim 1, wherein the biomass material is used to absorb at least one of target components in the effluent gas stream, wherein the target components comprise tetrafluoromethane, carbon dioxide, methane, sulfur dioxide, nitrogen oxides, volatile organic compounds, and/or hydrogen sulfide.

3. The biomass material of claim 1, wherein the algae biomass is carbonized algae.

4. The biomass material of claim 1, wherein the zeolite is selected from a group consisting of Zeolite 13X, Type A Zeolite, Zeolite Beta, H-ZSM-5 and the combination thereof.

5. The biomass material of claim 1, wherein the algae biomass is a mix of two or more species.

6. The biomass material of claim 1, wherein the algae biomass is a protein-rich algae.

7. The biomass material of claim 1, wherein the algae biomass has a protein content of at least 30 weight %.

8. The biomass material of claim 1, wherein the algae biomass is selected from a group consisted of Spirulina sp., Chlorella sp., Nannochloropsis sp., and the combination thereof.

9. The biomass material of claim 1, wherein the biomass material is consisted of the algae biomass and the zeolite.

10. The biomass material of claim 1, wherein the biomass material has a gas adsorption capacity more than 0.029 mol/g.
